(19) United States
(12) Patent Application Publication
(10) Pub. No.: US 2024/0361163 A1
(43) Pub. Date: Oct. 31, 2024

(54) QUANTIFICATION OF LIQUID FLOW RATE FOR LIQUID MIXTURE

(71) Applicant: Chevron U.S.A. Inc., San Ramon, CA (US)

(72) Inventor: Pamela Isobel Chacon, Magnolia, TX (US)

(21) Appl. No.: 18/306,708

(22) Filed: Apr. 25, 2023

(51) Int. Cl. G01F 1/44; G01F 1/88

(52) U.S. Cl. CPC G01F 1/44; G01F 1/88

(57) ABSTRACT

Properties of liquid flowing through a Venturi tube, operating characteristics of the Venturi tube, geometry of the Venturi tube, and correlation between Reynolds number and coefficient of discharge for the Venturi tube are used to determine a flow rate of liquid or liquid/liquid mixture in the Venturi tube. Determination of the Reynolds number is reiterated to increase the accuracy of the liquid flow rate measurement in the Venturi tube. The liquid flow rate in the Venturi tube is monitored to control the liquid flow.

### FIELD

The present disclosure relates generally to the field of monitoring liquid flow through a Venturi rube.

### BACKGROUND

A Venturi tube may be used to measure the rate of liquid flowing through a pipe. However, flow rate measurement via the Venturi tube may assume fixed coefficient of discharge and/or fixed fluid properties for the flow rate measurement. Variations in fluid properties, such as due to intermittent liquid/liquid emulsion, may cause error in flow rate measurement.

### SUMMARY

This disclosure relates to monitoring liquid flow. Venturi tube geometry information, Venturi tube operation information, liquid property information, Reynolds number-coefficient of discharge correlation information, and/or other information may be obtained. The Venturi tube geometry information may define geometry of a Venturi tube. The Venturi tube operation information may define operating characteristics of the Venturi tube. The liquid property information may define density, viscosity, and expansibility factor of liquid flowing through the Venturi tube. The Reynolds number-coefficient of discharge correlation information may define correlation between Reynolds number and coefficient of discharge for the Venturi tube.

A Reynolds number for the liquid flowing through the Venturi tube may be determined based on the geometry of the Venturi tube, the viscosity of the liquid flowing through the Venturi tube, an estimated liquid flow rate in the Venturi tube, and/or other information. A coefficient of discharge for the liquid flowing through the Venturi tube may be determined based on the Reynolds number for the liquid flowing through the Venturi tube, the correlation between Reynolds number and coefficient of discharge for the Venturi tube, and/or other information. A liquid flow rate in the Venturi tube may be determined based on the geometry of the Venturi tube, the operating characteristics of the Venturi tube, the expansibility factor of liquid flowing through the Venturi tube, the density of the liquid flowing through the Venturi tube, the coefficient of discharge for the liquid flowing through the Venturi tube, and/or other information. Determination of the Reynolds number, the coefficient of discharge, and the liquid flow rate in the Venturi tube may be iterated based on a comparison between the determined liquid flow rate and the estimated liquid flow rate and/or other information. Liquid flow monitoring for the Venturi tube based on the determined liquid flow rate in the Venturi tube may be facilitated.

A system for monitoring liquid flow may include one or more electronic storage, one or more processors and/or other components. The electronic storage may store information relating to a Venturi tube, Venturi tube geometry information, Venturi tube operation information, information relating to liquid flowing through the Venturi tube, liquid property information, Reynolds number-coefficient of discharge correlation information, information relating to a coefficient of discharge for the liquid flowing through the Venturi tube, information relating to a liquid flow rate in the Venturi tube, information relating to liquid flow monitoring for the Venturi tube, and/or other information.

The processor(s) may be configured by machine-readable instructions. Executing the machine-readable instructions may cause the processor(s) to facilitate monitoring liquid flow. The machine-readable instructions may include one or more computer program components. The computer program components may include one or more of a geometry component, an operation component, a liquid property component, a Reynolds number component, a correlation component, a coefficient of discharge component, a flow rate component, a monitoring component, and/or other computer program components.

The geometry component may be configured to obtain Venturi tube geometry information and/or other information. The Venturi tube geometry information may define geometry of a Venturi tube. In some implementations, the geometry of the Venturi tube may include an entrance diameter of the venturi tube and a throat diameter of the venturi tube.

The operation component may be configured to obtain Venturi tube operation information and/or other information. The Venturi tube operation information may define operating characteristics of the Venturi tube. In some implementations, the operating characteristics of the Venturi tube may include temperature, static pressure, and differential pressure.

The liquid property component may be configured to obtain liquid property information and/or other information. The liquid property information may define density, viscosity, and expansibility factor of liquid flowing through the Venturi tube. In some implementations, the liquid flowing through the Venturi tube may include a mixture of immiscible liquids.

The Reynolds number component may be configured to determine a Reynolds number for the liquid flowing through the Venturi tube. The Reynolds number for the liquid flowing through the Venturi tube may be determined based on the geometry of the Venturi tube, the viscosity of the liquid flowing through the Venturi tube, an estimated liquid flow rate in the Venturi tube, and/or other information.

The correlation component may be configured to obtain Reynolds number-coefficient of discharge correlation information and/or other information. The Reynolds number-coefficient of discharge correlation information may define correlation between Reynolds number and coefficient of discharge for the Venturi tube.

The coefficient of discharge component may be configured to determine a coefficient of discharge for the liquid flowing through the Venturi tube. The coefficient of discharge for the liquid flowing through the Venturi tube may be determined based on the Reynolds number for the liquid flowing through the Venturi tube, the correlation between Reynolds number and coefficient of discharge for the Venturi tube, and/or other information.

The flow rate component may be configured to determine a liquid flow rate in the Venturi tube. The liquid flow rate in the Venturi tube may be determined based on the geometry of the Venturi tube, the operating characteristics of the Venturi tube, the expansibility factor of liquid flowing through the Venturi tube, the density of the liquid flowing through the Venturi tube, the coefficient of discharge for the liquid flowing through the Venturi tube, and/or other information. Determination of the Reynolds number, the coefficient of discharge, and the liquid flow rate in the Venturi tube may be iterated based on a comparison between the determined liquid flow rate and the estimated liquid flow rate and/or other information. In some implementations, the determined liquid flow rate may include a mass flow rate of the liquid flowing through the Venturi tube.

In some implementations, iterative determination of the Reynolds number, the coefficient of discharge, and the liquid flow rate in the Venturi tube may be performed using linear regression. Iterative determination of the Reynolds number, the coefficient of discharge, and the liquid flow rate in the Venturi tube may include use of a previously determined liquid flow rate in the Venturi tube as a newly estimated liquid flow rate in the Venturi tube. Iterative determination of the Reynolds number, the coefficient of discharge, and the liquid flow rate in the Venturi tube may be performed until a difference between the estimated liquid flow rate and the determined liquid flow rate is below a liquid flow rate error threshold.

The monitoring component may be configured to facilitate liquid flow monitoring for the Venturi tube. The liquid flow monitoring for the Venturi tube may be performed based on the determined liquid flow rate in the Venturi tube and/or other information.

In some implementations, facilitation of the liquid flow monitoring for the Venturi tube based on the determined liquid flow rate in the Venturi tube may include determination of a line condition volume flow rate and/or a standard condition volume flow rate based on the mass flow rate of the liquid flowing through the Venturi tube and/or other information.

In some implementations, the Venturi tube may be connected to a pipe for a compressor. Facilitation of the liquid flow monitoring for the Venturi tube based on the determined liquid flow rate in the Venturi tube may include prevention of a surge in the compressor based on the determined liquid flow rate in the Venturi tube and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for monitoring liquid flow.

FIGS. 2A and 2B illustrate an example method for monitoring liquid flow.

FIG. 3 illustrates an example Venturi tube.

FIG. 4 illustrates an example correlation between Reynolds number and coefficient of discharge.

FIG. 5 illustrates an example flow diagram for monitoring liquid flow.

### DETAILED DESCRIPTION

The present disclosure relates to monitoring liquid flow. Properties of liquid flowing through a Venturi tube, operating characteristics of the Venturi tube, geometry of the Venturi tube, and correlation between Reynolds number and coefficient of discharge for the Venturi tube are used to determine a flow rate of liquid or liquid/liquid mixture in the Venturi tube. Determination of the Reynolds number is reiterated to increase the accuracy of the liquid flow rate measurement in the Venturi tube. The liquid flow rate in the Venturi tube is monitored to control the liquid flow.

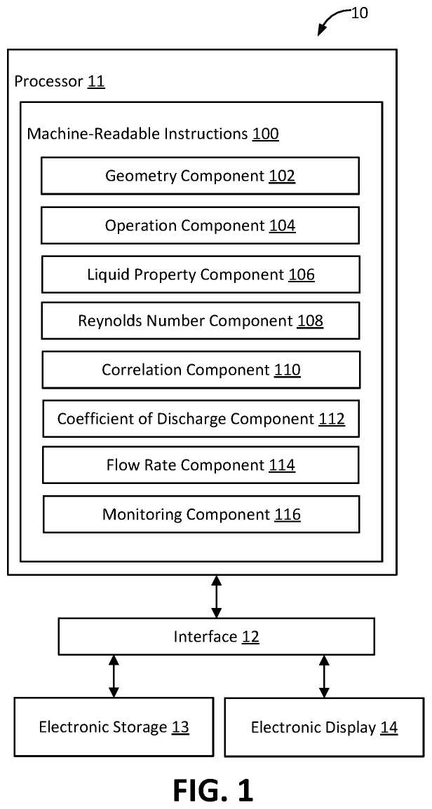

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Venturi tube geometry information, Venturi tube operation information, liquid property information, Reynolds number-coefficient of discharge correlation information, and/or other information may be obtained by the processor 11. The Venturi tube geometry information may define geometry of a Venturi tube. The Venturi tube operation information may define operating characteristics of the Venturi tube. The liquid property information may define density, viscosity, and expansibility factor of liquid flowing through the Venturi tube. The Reynolds number-coefficient of discharge correlation information may define correlation between Reynolds number and coefficient of discharge for the Venturi tube.

A Reynolds number for the liquid flowing through the Venturi tube may be determined by the processor 11 based on the geometry of the Venturi tube, the viscosity of the liquid flowing through the Venturi tube, an estimated liquid flow rate in the Venturi tube, and/or other information. A coefficient of discharge for the liquid flowing through the Venturi tube may be determined by the processor 11 based on the Reynolds number for the liquid flowing through the Venturi tube, the correlation between Reynolds number and coefficient of discharge for the Venturi tube, and/or other information. A liquid flow rate in the Venturi tube may be determined by the processor 11 based on the geometry of the Venturi tube, the operating characteristics of the Venturi tube, the expansibility factor of liquid flowing through the Venturi tube, the density of the liquid flowing through the Venturi tube, the coefficient of discharge for the liquid flowing through the Venturi tube, and/or other information. Determination of the Reynolds number, the coefficient of discharge, and the liquid flow rate in the Venturi tube may be iterated by the processor 11 based on a comparison between the determined liquid flow rate and the estimated liquid flow rate and/or other information. Liquid flow monitoring for the Venturi tube based on the determined liquid flow rate in the Venturi tube may be facilitated by the processor 11.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to a Venturi tube, Venturi tube geometry information, Venturi tube operation information, information relating to liquid flowing through the Venturi tube, liquid property information, Reynolds number-coefficient of discharge correlation information, information relating to a coefficient of discharge for the liquid flowing through the Venturi tube, information relating to a liquid flow rate in the Venturi tube, information relating to liquid flow monitoring for the Venturi tube, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to a Venturi tube, Venturi tube geometry information, Venturi tube operation information, information relating to liquid flowing through the Venturi tube, liquid property information, Reynolds number-coefficient of discharge correlation information, information relating to a coefficient of discharge for the liquid flowing through the Venturi tube, information relating to a liquid flow rate in the Venturi tube, information relating to liquid flow monitoring for the Venturi tube, and/or other information.

A Venturi tube (Venturi meter) may be used to measure the flow rate of liquid flowing through a pipe. Flow rate measurement using a Venturi tube may assume fixed fluid properties and/or coefficient of discharge. In applications with varying fluid properties, such as in the presence of intermittent liquid/liquid emulsions, this assumption may result in error in the measured flow rate, which may in turn impact systems that depend on the measured flow rate for operational success. For example, a subsea compressor may be used to separate gas from liquid. An accurate flow rate of liquid flowing through the subsea compressor may be needed for surge control. However, emulsion of different types of liquid (e.g., liquid water-liquid oil emulsion) flowing through the Venturi tube may result in inaccuracy in flow rate measurement. Use of inaccurate flow rate in surge control for the compressor may result in compressor surge, which may be catastrophic for the compressor.

The current disclosure provides a tool to accurately measure liquid flow rate using a Venturi tube with changing fluid properties and/or coefficient of discharge. Fluid properties of liquid flowing through the Venturi tube and a curve that defines the relationship between the Reynolds number and the coefficient of discharge may be used to calculate the flow rate with increased accuracy than traditional Venturi measurement systems. The Reynolds number and the coefficient of discharge may be dynamically calculated based on the properties of liquid flowing through the Venturi tube to enable accurate flow rate measurement even in the presence of liquid/liquid emulsions. Calculation of the Reynolds number and the coefficient of discharge may be reiterated based on comparison between estimated liquid flow rate and calculated liquid flow rate to increase the accuracy of liquid flow rate calculation.

For example, without the dynamic and iterative determination of the Reynolds number and the coefficient of discharge, liquid flow rate measurement may tend to error on the side of the calculated liquid flow rate being greater than the actual liquid flow rate, with an average error of 11% and a range of error between 1 to 38%. With the dynamic and iterative determination of the Reynolds number and the coefficient of discharge, liquid flow rate measurement may tend to error on the side of the calculated liquid flow rate being less than the actual liquid flow rate, with an average error of −2% and a range of error between −12 to 1%. Thus, the tool of the current disclosure reduces the amount of error in liquid flow rate measurement and changes the error from overestimation to underestimation. Underestimation of liquid flow rate may be beneficial for use of the liquid flow rate in equipment operation. For example, liquid flow rate may be used for compressor surge protection, and underestimation of liquid flow rate may result in safer/more conservative operation of the equipment to prevent surge in the compressor.

While the present disclosure is described with respect to a Venturi tube, use of the current disclosure for liquid flow rate measurement via other types of flow restrictions are contemplated.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate monitoring liquid flow. The machine-readable instructions 100 may include one or more computer program components. The machine-readable instructions 100 may include a geometry component 102, an operation component 104, a liquid property component 106, a Reynolds number component 108, a correlation component 110, a coefficient of discharge component 112, a flow rate component 114, a monitoring component 116, and/or other computer program components.

The geometry component 102 may be configured to obtain Venturi tube geometry information and/or other information. Obtaining Venturi tube geometry information may include one or more of accessing, acquiring, analyzing, determining, examining, generating, identifying, loading, locating, measuring, opening, receiving, retrieving, reviewing, selecting, storing, and/or otherwise obtaining the Venturi tube geometry information. The geometry component 102 may obtain Venturi tube geometry information from one or more locations. For example, the geometry component 102 may obtain Venturi tube geometry information from a storage location, such as the electronic storage 13, electronic storage of a device accessible via a network, and/or other locations. The geometry component 102 may obtain Venturi tube geometry information from one or more hardware components (e.g., a computing device) and/or one or more software components (e.g., software running on a computing device).

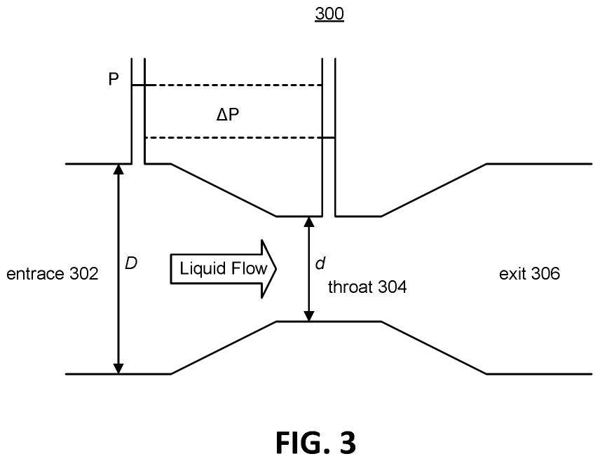

The Venturi tube geometry information may define geometry of a Venturi tube. The Venturi tube may refer to a device for measuring the flow of fluid. The Venturi tube may include a tube with a narrow center section and wider ends so that the fluid flows through the center section at a higher velocity than through the end sections to create a pressure difference. FIG. 3 illustrates an example Venturi tube 300. The Venturi tube 300 may include an entrance 302 with a diameter D and a throat 304 with a diameter d. An exit 306 of the Venturi tube 300 may or may not have the same diameter as the entrance 302. The diameter of the pipe to which the Venturi tube 300 is connected may have the same diameter as the entrance diameter D and/or the exit diameter d. Liquid flowing through the Venturi tube 300 may result in a pressure difference ΔP between the entrance 302 and the throat 304.

The geometry of the Venturi tube may refer to shape, arrangement, dimension, and/or other spatial aspects of the Venturi tube. The geometry of the Venturi tube may be static or dynamic. For example, the geometry of the Venturi tube may include an entrance diameter (D) of the venturi tube and a throat diameter (d) of the Venturi tube. A beta ratio (B) of the Venturi tube may be determined based on the entrance diameter of the Venturi tube, the throat diameter of the Venturi tube, and/or other information. For example, the beta ratio (B) of the Venturi tube may be calculated as the ratio of the throat diameter to the entrance diameter (β=d/D). Other geometry of the Venturi tube is contemplated.

In some implementations, the temperature at which the geometry of the Venturi tube is measured may be different from the temperature at which the Venturi tube is operating. The temperature at which the geometry of the Venturi tube is measured may be higher or lower than the temperature at which the Venturi tube is used to measure fluid flow rate. The temperature at which the geometry of the Venturi tube is measured may be referred to as the reference temperature (Tᵣ) and the geometry of the Venturi tube measured at the reference temperature may be referred to as the reference geometry (Dᵣ, dᵣ). In some implementations, the same reference temperature may be used for measurement of different parts of the Venturi tube. In some implementations, different reference temperatures may be used for measurement of different parts of the Venturi tube. For example, the reference temperature (T_{r,entrance}, T_{r,exit}, T_{r,pipe}) at which the entrance/exit/pipe diameter is measured may be different from the reference temperature (T_{r,throat}) at which the throat diameter is measured.

Based on the Venturi tube being used at temperature different from the reference temperature, the reference geometry of the Venturi tube may be modified to determine the geometry of the Venturi tube during operation. For example, the entrance diameter (D) and the throat diameter (d) of the Venturi tube during operation may be calculated using the following relationships between the reference temperature (T_{r,entrance}, T_{r,throat}), operating temperature (T), thermal expansion coefficient of the materials (α_{entrance}, αₜₕᵣₒₐₜ), reference entrance diameter (Dᵣ), and reference throat diameter (dᵣ). The thermal expansion coefficient of the materials may be same or different at different parts of the Venturi tube. For example, the thermal expansion coefficient of the Venturi tube at the throat and the entrance of the Venturi tube may be same or different:

$$d = {d}_{r} [ 1 + {α}_{t h r o a t} ( T - {T}_{r , throat} ) ]$$

$$D = {D}_{r} [ 1 + {α}_{e n t r a n c e} ( T - {T}_{r , entrance} ) ]$$

The Venturi tube geometry information may define geometry of a Venturi tube by including information that characterizes, describes, delineates, identifies, is associated with, quantifies, reflects, sets forth, and/or otherwise defines one or more of value, property, quality, quantity, attribute, feature, and/or other aspects of the geometry of the Venturi tube. The Venturi tube geometry information may directly and/or indirectly define geometry of a Venturi tube. For example, the Venturi tube geometry information may define operating geometry of a Venturi tube by including information that specifies the type and/or the value of the geometry of the Venturi tube and/or information that may be used to determine the type and/or the value of the geometry of the Venturi tube. Other types of Venturi tube geometry information are contemplated.

The operation component 104 may be configured to obtain Venturi tube operation information and/or other information. Obtaining Venturi tube operation information may include one or more of accessing, acquiring, analyzing, determining, examining, generating, identifying, loading, locating, measuring, opening, receiving, retrieving, reviewing, selecting, storing, and/or otherwise obtaining the Venturi tube operation information. The operation component 104 may obtain Venturi tube operation information from one or more locations. For example, the operation component 104 may obtain Venturi tube operation information from a storage location, such as the electronic storage 13, electronic storage of a device accessible via a network, and/or other locations. The operation component 104 may obtain Venturi tube operation information from one or more hardware components (e.g., a computing device, a temperature sensor, a pressure sensor) and/or one or more software components (e.g., software running on a computing device). For example, the system 10 may include temperature sensor, a pressure sensor, and/or other sensors, and the operation component 104 may obtain Venturi tube operation information by using the temperature sensor, the pressure sensor, and/or other sensors to determine/measure operating characteristics of the Venturi tube. Use of other sensors is contemplated.

The Venturi tube operation information may define operating characteristics of the Venturi tube. Operating characteristics of the Venturi tube may refer to characteristics of the Venturi tube during an operation that utilizes the Venturi tube for flow rate measurement. Operating characteristics of the Venturi tube may refer to attribute, quality, configuration, parameter, and/or characteristics of matter inside, within, and/or around the Venturi tube during an operation that utilizes the Venturi tube for flow rate measurement. For example, the operating characteristics of the Venturi tube may include temperature, static pressure, differential pressure, and/or other operating characteristics of the Venturi Tube. The temperature may refer to the degree or intensity of heat present in/around the Venturi tube and/or in the materials inside the Venturi tube. The state pressure may refer to the pressure at a point along the Venturi tube (e.g., the entrance, throat, or the exit of the Venturi tube). For example, referring to FIG. 3, the static pressure (P) may refer to the pressure measured at the entrance 302. The differential pressure may refer to may refer to the difference in pressure between two points along the Venturi tube. For example, referring to FIG. 3, the differential pressure (ΔP) may refer to the difference in pressure between the entrance 302 and the throat 304.

In some implementations, one or more properties of liquid flowing through the Venturi tube may be determined based on the operating characteristic of the Venturi Tube and/or other information. For example, density, viscosity, expansibility factor, and/or other properties of liquid flowing through the Venturi tube may be determined based on the temperature, pressure, and/or other operating characteristic of the Venturi tube.

The Venturi tube operation information may define operating characteristics of the Venturi tube by including information that characterizes, describes, delineates, identifies, is associated with, quantifies, reflects, sets forth, and/or otherwise defines one or more of value, property, quality, quantity, attribute, feature, and/or other aspects of the operating characteristics of the Venturi tube. The Venturi tube operation information may directly and/or indirectly define operating characteristics of the Venturi tube. For example, the Venturi tube operation information may define operating characteristics of the Venturi tube by including information that specifies the type and/value of operating characteristics of the Venturi tube and/or information that may be used to determine the type and/or value of the operating characteristics of the Venturi tube. Other types of Venturi tube operation information are contemplated.

The liquid property component 106 may be configured to obtain liquid property information and/or other information. Obtaining liquid property information may include one or more of accessing, acquiring, analyzing, determining, examining, generating, identifying, loading, locating, measuring, opening, receiving, retrieving, reviewing, selecting, storing, and/or otherwise obtaining the liquid property information. The liquid property component 106 may obtain liquid property information from one or more locations. For example, the liquid property component 106 may obtain liquid property information from a storage location, such as the electronic storage 13, electronic storage of a device accessible via a network, and/or other locations. The liquid property component 106 may obtain liquid property information from one or more hardware components (e.g., a computing device, a sensor) and/or one or more software components (e.g., software running on a computing device). For example, the liquid property component 106 may obtain liquid property information by using one or more liquid/fluid property sensors to directly determine/measure properties of liquid and/or by using one or more liquid/fluid composition sensors to determine/measure composition of liquid and determine properties of liquid based on the composition of liquid.

The liquid property information may define properties of liquid flowing through the Venturi tube. The properties of the liquid flowing through the Venturi tube may include density, viscosity, expansibility factor, and/or other properties of liquid flowing through the Venturi tube. Density (ρ) may refer to mass of a unit volume of the liquid flowing through the Venturi tube. Viscosity (μ) may refer to resistance of the liquid flowing through the Venturi tube to a change in shape or movement of one part relative to another. Expansibility factor (ε) may refer to the ratio of the flow rate for a compressible fluid to its flow rate as an incompressible fluid, for the same Reynolds number and geometry. Expansibility factor may be equal to one for incompressible fluid.

The liquid flowing through the Venturi tube may include a single type of liquid, multiple types of liquid, and/or other types of liquid. For example, the liquid flowing through the Venturi tube may include a mixture of immiscible liquids. The composition/mixture of liquid flowing through the Venturi tube may change, and the properties (e.g., density, viscosity, expansibility factor) of the liquid flowing through the Venturi tube may change. For example, the liquid flowing through the Venturi tube may at different times include liquid water, liquid oil, or emulsion of liquid water and liquid oil. Emulsion of emulsion of liquid water and liquid oil may include mixture of liquid water and liquid oil that are normally immiscible due to liquid-liquid phase separation. The properties of the liquid flowing through the Venturi tube may depend on whether the liquid includes liquid water, liquid oil, or emulsion of liquid water and liquid oil (e.g., oil-in-water emulsion, water-in-oil emulsion).

The liquid property information may define properties of liquid flowing through the Venturi tube by including information that characterizes, describes, delineates, identifies, is associated with, quantifies, reflects, sets forth, and/or otherwise defines one or more of value, property, quality, quantity, attribute, feature, and/or other aspects of the properties of liquid flowing through the Venturi tube. The liquid property information may directly and/or indirectly define properties of liquid flowing through the Venturi tube. For example, the liquid property information may define properties of liquid flowing through the Venturi tube by including information that specifies the type and/value of properties of liquid flowing through the Venturi tube and/or information that may be used to determine the type and/or value of the properties of liquid flowing through the Venturi tube. Other types of liquid property information are contemplated.

In some implementations, obtaining the liquid property information may include obtaining known properties of liquid flowing through the Venturi tube. In some implementations, obtaining the liquid property information may include making assumptions about properties of liquid flowing through the Venturi tube. In some implementations, obtaining the liquid property information may include calculating properties of liquid flowing through the Venturi tube.

The Reynolds number component 108 may be configured to determine a Reynolds number for the liquid flowing through the Venturi tube. Determining the Reynolds number for the liquid flowing through the Venturi tube may include ascertaining, approximating, calculating, establishing, estimating, finding, identifying, obtaining, quantifying, selecting, setting, and/or otherwise determining the value of the Reynolds number for the liquid flowing through the Venturi tube. The Reynolds number (Re) may refer to a dimensionless quantity that is used to predict fluid flow patterns by measuring the ratio between inertial and viscous forces. The value of the Reynolds number may be tied to the type(s) of liquid flowing through the Venturi tube. Dynamically determining the Reynolds number based on the type(s) of liquid flowing through the Venturi tube enables more accurate flow rate measurement.

The Reynolds number for the liquid flowing through the Venturi tube may be determined based on the geometry of the Venturi tube, the viscosity (μ) of the liquid flowing through the Venturi tube, an estimated liquid flow rate (q_{m,initial}) in the Venturi tube, and/or other information. The geometry of the Venturi tube used to determine the Reynolds number may include the entrance diameter (D), the throat diameter (d), other diameter, and/or other geometry of the Venturi tube. The estimated liquid flow rate may include an assumption about the liquid flow rate in the Venturi tube. For example, the Reynolds number for the liquid flowing through the Venturi tube may be determined using the following. Other determination of the Reynolds number is contemplated.

$$R {e}_{D} = \frac{4 {q}_{m , initial}}{π μ D}$$

The Reynolds number may be used to determine the coefficient of discharge for the liquid flowing through the Venturi tube, and the coefficient of discharge may be used to determine (calculate) the liquid flow rate (qₘ) in the Venturi tube. The determined liquid flow rate (determined from the coefficient of discharge) may be compared with the estimated liquid flow rate to determine the difference (error) between the determined liquid flow rate and the estimated liquid flow rate. Determination of the Reynolds number, the coefficient of discharge, and the liquid flow rate in the Venturi tube may be iterated based on a comparison between the determined liquid flow rate and the estimated liquid flow rate. Based on the difference between the determined liquid flow rate and the estimated liquid flow rate (q_{m,initial}−qₘ) being larger than a threshold difference/error value (liquid flow rate error threshold), determination of the Reynolds number may be performed again, followed by determination of the coefficient of discharge for the liquid flowing through the Venturi tube and the liquid flow rate in the Venturi tube. Determination of the Reynolds number, the coefficient of discharge, and the liquid flow rate in the Venturi tube may be iterated using linear regression and/or other techniques. When the Reynolds number determination is iterated, the previously determined liquid flow rate (qₘ), rather than the estimated liquid flow rate (q_{m,initial}), may be used, as shown below.

$$R {e}_{D} = \frac{4 {q}_{m}}{π μ D}$$

That is, the previously determined liquid flow rate may be used as the newly estimated liquid flow rate in the Venturi tube for the determination of the Reynolds number. Newly determined Reynolds number may be used to re-determine the coefficient of discharge for the liquid flowing through the Venturi tube, and the newly determined coefficient of discharge may be used to re-determine the liquid flow rate (qₘ) in the Venturi tube.

The newly determined liquid flow rate may be compared with the previously determined liquid flow rate (which was used as the estimated liquid flow rate), and based on the difference between the newly determined liquid flow rate and the previously determined liquid flow rate being larger than the threshold difference/error value (liquid flow rate error threshold), determination of the Reynolds number, the coefficient of discharge for the liquid flowing through the Venturi tube, and the liquid flow rate in the Venturi tube may be performed again, with the newly determined liquid flow rate being used to determine the Reynolds number. The iterative determination of the Reynolds number, the coefficient of discharge, and the liquid flow rate in the Venturi tube may be performed until the difference between the estimated liquid flow rate (e.g., initial estimated liquid flow rate, previously determined liquid flow rate) and the determined liquid flow rate (e.g., newly determined liquid flow rate from the iteration) is below the threshold difference/error value.

The correlation component 110 may be configured to obtain Reynolds number-coefficient of discharge correlation information and/or other information. Obtaining Reynolds number-coefficient of discharge correlation information may include one or more of accessing, acquiring, analyzing, determining, examining, generating, identifying, loading, locating, measuring, opening, receiving, retrieving, reviewing, selecting, storing, and/or otherwise obtaining the Reynolds number-coefficient of discharge correlation information. The correlation component 110 may obtain Reynolds number-coefficient of discharge correlation information from one or more locations. For example, the correlation component 110 may obtain Reynolds number-coefficient of discharge correlation information from a storage location, such as the electronic storage 13, electronic storage of a device accessible via a network, and/or other locations. The correlation component 110 may obtain Reynolds number-coefficient of discharge correlation information from one or more hardware components (e.g., a computing device) and/or one or more software components (e.g., software running on a computing device).

The Reynolds number-coefficient of discharge correlation information may define correlation between Reynolds number and coefficient of discharge for the Venturi tube. The correlation between Reynolds number and coefficient of discharge for the Venturi tube may refer to relationship and/or connection between values of the Reynolds number and values of the coefficient of discharge for the Venturi tube. For example, the correlation between Reynolds number and coefficient of discharge for the Venturi tube may include a curve that defines values of the coefficient of discharge for the Venturi tube as a function of values of the Reynolds number. The Reynolds number-coefficient of discharge curve may be specific to the geometry of the Venturi tube, manufacturing variation, upstream installation piping, and/or other factors. The correlation between Reynolds number and coefficient of discharge for the Venturi tube may be determined based on experiments conducted on the Venturi tube and/or based on previously quantified correlation (e.g., use of previously quantified Reynolds number-coefficient of discharge curve, adjustment of previously quantified Reynolds number-coefficient of discharge curve).

The Reynolds number-coefficient of discharge correlation information may define correlation between Reynolds number and coefficient of discharge for the Venturi tube by including information that characterizes, describes, delineates, identifies, is associated with, quantifies, reflects, sets forth, and/or otherwise defines one or more of value, property, quality, quantity, attribute, feature, and/or other aspects of the correlation between Reynolds number and coefficient of discharge for the Venturi tube. The Reynolds number-coefficient of discharge correlation information may directly and/or indirectly define correlation between Reynolds number and coefficient of discharge for the Venturi tube. For example, the Reynolds number-coefficient of discharge correlation information may define correlation between Reynolds number and coefficient of discharge for the Venturi tube by including information that specifies the correspondence between values of the Reynolds number and values of the coefficient of discharge and/or information that may be used to determine the correspondence between values of the Reynolds number and values of the coefficient of discharge. Other types of Reynolds number-coefficient of discharge correlation information are contemplated.

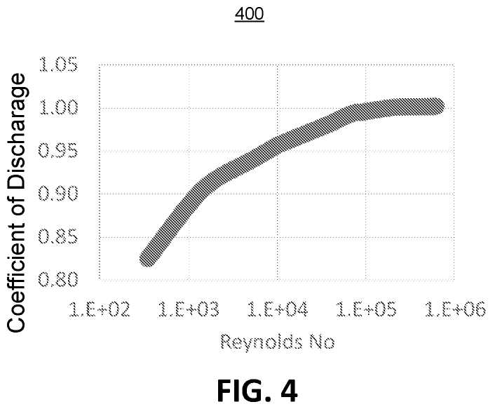

FIG. 4 illustrates an example correlation between Reynolds number and coefficient of discharge. In FIG. 4, a curve 400 defines the relationship between the Reynolds number values and the coefficient of discharge values. Other correlations between the Reynolds number and the coefficient of discharge are contemplated.

In the curve 400, with high Reynolds number values (e.g., 10,000 and more), the value of coefficient of discharge plateaus, and changes in the Reynolds number has small/minimal impact on the coefficient of discharge value and the changes in the Reynolds number may not need to be considered when performing flow rate measurement. With smaller Reynolds number values (e.g., less than 10,000), changes in the Reynolds number has greater impact on the coefficient of discharge value and not taking the changes in the Reynolds number into account for flow rate measurement may result in inaccurate measurement. For example, water/oil emulsion may result in a low value of Reynolds number (e.g., 300-5,000), and the Reynold number for the liquid may need to be determined to accurately measure the liquid flow rate.

The coefficient of discharge component 112 may be configured to determine a coefficient of discharge for the liquid flowing through the Venturi tube. Determining the coefficient of discharge for the liquid flowing through the Venturi tube may include ascertaining, approximating, calculating, establishing, estimating, finding, identifying, obtaining, quantifying, selecting, setting, and/or otherwise determining the value of the coefficient of discharge for the liquid flowing through the Venturi tube. The coefficient of discharge (C) may refer to a dimensionless quantity that is used to determine discharge rate of liquid flowing through a pipe. The coefficient of discharge may be a ratio of the actual discharge to the ideal discharge for fluid flow.

The coefficient of discharge for the liquid flowing through the Venturi tube may be determined based on the Reynolds number for the liquid flowing through the Venturi tube, the correlation between Reynolds number and coefficient of discharge for the Venturi tube, and/or other information. The value of the Reynolds number for the liquid flowing through the Venturi tube may be matched to the value of the coefficient of discharge for the liquid flowing through the Venturi tube by using the correlation (relationship and/or connection) between the Reynolds number and the coefficient of discharge for the Venturi tube. For example, the value of the coefficient of discharge (y-value) on the curve 400 may be found that has the value of the Reynolds number (x-value). Changes in the composition/properties of fluid flowing through the Venturi tube may change the value of the Reynolds number, and the value of the coefficient of discharge may be determined to account for the change in liquid composition/properties when determining liquid flow rate.

The flow rate component 114 may be configured to determine a liquid flow rate in the Venturi tube. Determining the liquid flow rate in the Venturi tube may include ascertaining, approximating, calculating, establishing, estimating, finding, identifying, obtaining, quantifying, selecting, setting, and/or otherwise determining the value of the liquid flow rate in the Venturi tube. The liquid flow rate in the Venturi tube may refer to the rate/speed at which the liquid is moving through the Venturi tube. In some implementations, the liquid flow rate may include a mass flow rate of the liquid flowing through the Venturi tube—the mass of the liquid moving through the Venturi tube per unit time and/or a volume flow rate of the liquid flowing through the Venturi tube—the volume of the liquid moving through the Venturi tube per unit time.

The liquid flow rate in the Venturi tube may be determined based on the geometry of the Venturi tube, the operating characteristics of the Venturi tube, the expansibility factor (ε) of liquid flowing through the Venturi tube, the density (ρ) of the liquid flowing through the Venturi tube, the coefficient of discharge (C) for the liquid flowing through the Venturi tube, and/or other information. For example, the liquid mass flow rate (qₘ) in the Venturi tube may be determined using the following, where the geometry of the Venturi tube includes the beta ratio (β) and the throat diameter (d), and the operating characteristics of the Venturi tube includes the differential pressure (ΔP). Other determination of the liquid flow rate is contemplated.

$${q}_{m} = \frac{C}{\sqrt{1 - {β}^{4}}} ε \frac{π}{4} {d}^{2} \sqrt{2 Δ P ρ}$$

Determination of the liquid flow rate may be iterated based on a comparison between the determined liquid flow rate qₘ) and the estimated liquid flow rate q_{m,initial}). Based on the difference between the determined liquid flow rate and the estimated liquid flow rate (q_{m,initial}−qₘ) being larger than (or larger than equal to) a threshold difference/error value, determination of the liquid flow rate may be performed again by recalculating the Reynolds number, recalculating the coefficient of discharge based on the recalculated Reynolds number, and recalculating liquid flow rate based on the recalculated coefficient of discharge. This process may repeat until the difference between the latest calculated liquid flow rate and the previously calculated liquid flow rate is lower or equal to (or lower than) the threshold difference/error value.

The monitoring component 116 may be configured to facilitate liquid flow monitoring for the Venturi tube. The liquid flow monitoring for the Venturi tube may refer to monitoring flow of liquid through the Venturi tube. The liquid flow monitoring for the Venturi tube may refer to monitoring the liquid flow rate in the Venturi tube. The liquid flow monitoring for the Venturi tube may be performed based on the determined liquid flow rate in the Venturi tube and/or other information. The liquid flow monitoring for the Venturi tube may be performed based on the determined liquid flow rate in the Venturi tube at a particular moment in time and/or at different moments in time.

The monitoring component 116 may facilitate use of the liquid flow rate (determined liquid flow rate) in the Venturi tube to perform liquid flow monitoring for the Venturi tube. The monitoring component 116 may facilitate use of information relating to and/or determined from the liquid flow rate in the Venturi tube to perform liquid flow monitoring for the Venturi tube. For example, facilitating liquid flow monitoring for the Venturi tube may include: (1) presenting the liquid flow rate in the Venturi tube on the electronic display 14, (2) presenting information relating to and/or determined from the liquid flow rate in the Venturi tube on the electronic display 14, (3) presenting results of liquid flow monitoring for the Venturi tube on the electronic display 14, (4) providing information relating to and/or determined from the liquid flow rate in the Venturi tube to one or more liquid flow monitoring processes, and/or (5) performing liquid flow monitoring for the Venturi tube using information relating to and/or determined from the liquid flow rate in the Venturi tube.

In some implementations, facilitation of the liquid flow monitoring for the Venturi tube based on the liquid flow rate in the Venturi tube may include determination of a line condition volume flow rate and/or a standard condition volume flow rate based on the mass flow rate of the liquid flowing through the Venturi tube and/or other information. The line condition volume flow rate may refer to the volume flow rate of the liquid measured/calculated at operating conditions (e.g., pressure, temperature). The standard condition volume flow rate may refer to the volume flow rate of the liquid measured/calculated at standard conditions (e.g., standard pressure, standard temperature). The line condition volume flow rate (qᵥ) and the standard condition volume flow rate (Qᵥ) may be determined using the following, where density used is the density at operating temperature and pressure (ρ) or the density at standard temperature and pressure ρₛₜₚ. Other determination of the line condition volume flow rate and standard condition volume flow rate is contemplated.

$${q}_{v} = \frac{{q}_{m}}{ρ} , {Q}_{v} = \frac{{q}_{m}}{{ρ}_{s t p}}$$

In some implementations, facilitation of the liquid flow monitoring for the Venturi tube based on the liquid flow rate in the Venturi tube may include generation of one or more alarms based on the liquid flow rate in the Venturi tube and/or other information. For example, an alarm may be generated based on the liquid flow rate in the Venturi tube reaching a certain value and/or the rate at which the liquid flow rate in the Venturi tube is changing reaching a certain rate. Different alarms may be generated based on the liquid flow rate reaching different values and/or the rate at which the liquid flow rate is changing reaching different certain rates. Other types of alarms are contemplated.

In some implementations, facilitation of the liquid flow monitoring for the Venturi tube based on the liquid flow rate in the Venturi tube may include recommendation and/or automation of one or more operations based on the liquid flow rate in the Venturi tube and/or other information. For example, the liquid flow rate (and/or information determined from the liquid flow rate) may be used in a control system to keep equipment connected to the Venturi tube operational. For instance, equipment may require liquid flow rate to stay within a certain range, and the liquid flow rate falling outside that range may cause operational issues and/or danger to the equipment. Based on the liquid flow rate falling outside the range, one or more operations may be recommended and/or automatically performed to keep the equipment running properly.

For example, the Venturi tube may be connected to a pipe for a compressor. Facilitation of the liquid flow monitoring for the Venturi tube based on the liquid flow rate in the Venturi tube may include prevention of a surge in the compressor based on the liquid flow rate in the Venturi tube and/or other information. The surge in the compressor may be prevented manually and/or automatically. For example, based on the liquid flow rate in the Venturi tube reaching one surge threshold value, an alarm may be generated to warn the personnel about potential issues with the operation of the compressor. Based on the liquid flow rate in the Venturi tube reaching another surge threshold value, liquid flow to the compressor may be automatically controlled to change the liquid flow rate and/or the compressor may be automatically shut down. Use of the liquid flow rate for other equipment/operations is contemplated.

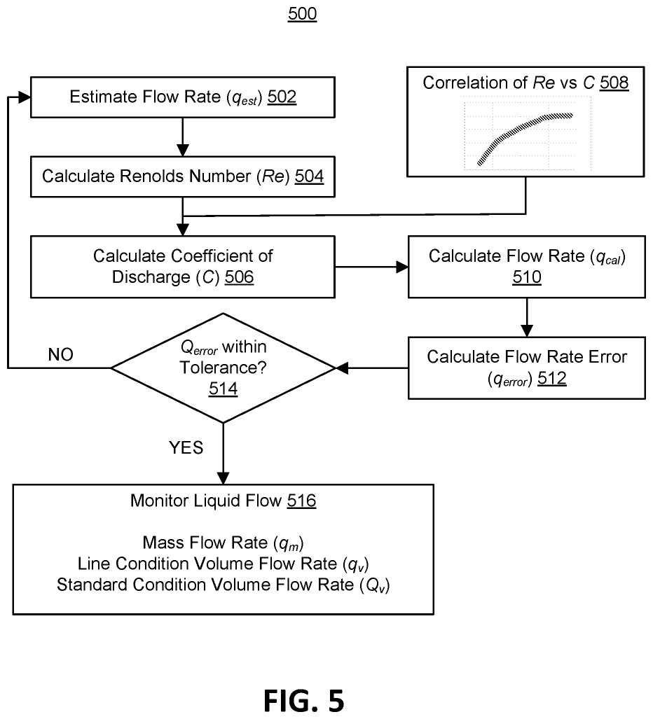

FIG. 5 illustrates an example flow diagram 500 for monitoring liquid flow. At step 502, liquid flow rate in a Venturi tube may be estimated. At step 504, the estimated liquid flow rate (qₑₛₜ) may be used to calculate the Reynolds number (Re). At step 506, a correlation of the Reynolds number (Re) versus the coefficient of discharge (C) 508 may be used to calculate the coefficient of discharge for the liquid flowing through the Venturi tube. At step 510, the coefficient of discharge may be used to calculate the liquid flow rate (q_{cal}) in the Venturi tube. At step 512, the liquid flow rate error (qₑᵣᵣₒᵣ) may be calculated as the difference between the calculated liquid flow rate (q_{cal}) and the estimated liquid flow rate (qₑₛₜ). If the liquid flow rate error (qₑᵣᵣₒᵣ) is not within tolerance (e.g., larger than an error threshold), the process may return to step 502 to recalculate the liquid flow rate. At step 502, previously calculated liquid flow rate (q_{cal}) may be used as the new estimated liquid flow rate (qₑₛₜ). If the liquid flow rate error (qₑᵣᵣₒᵣ) is within tolerance, the process may continue to step 516, where liquid flow is monitored using the calculated liquid flow rate (q_{cal}). Monitoring the liquid flow may include calculation and reporting of the mass flow rate (qₘ), the line condition volume flow rate (qᵥ), and/or the standard condition volume rate (Qᵥ) of the liquid. Monitoring the liquid flow may include automatic control of equipment. For example, monitoring the liquid flow may include, based on the liquid flow rate, automatically controlling (adjusting) flow of liquid through a compressor to prevent a surge in the compressor and/or automatically shutting down the compressor to prevent damage to the compressor.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). A machine-readable medium may include non-transitory computer-readable medium. For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11. The system 10 may be implemented in a single computing device, across multiple computing devices, in a client-server environment, in a cloud environment, and/or in other devices/configuration of devices. The system 10 may be implemented using a computer, a desktop, a laptop, a phone, a tablet, a mobile device, a server, and/or other computing devices.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

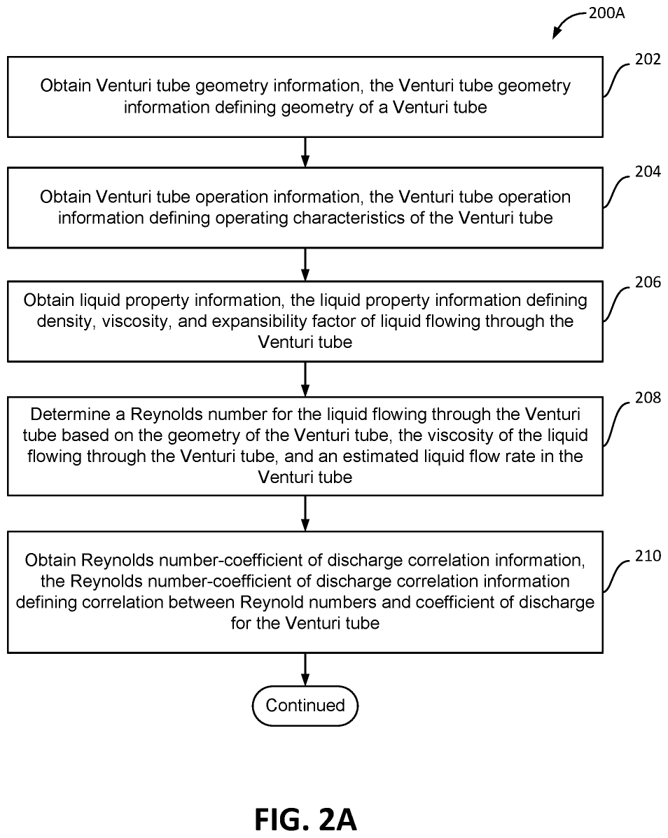

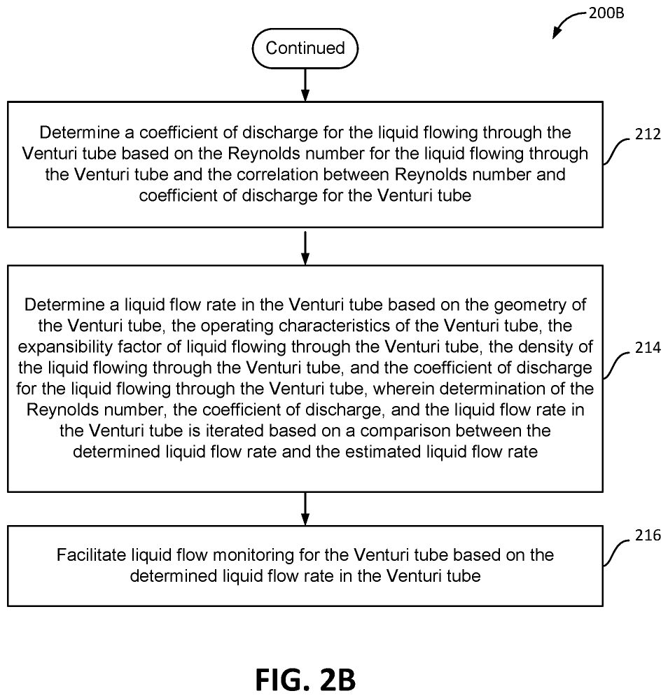

FIGS. 2A and 2B illustrate an example method 200A, 200B for monitoring liquid flow. The operations of method 200A, 200B presented below are intended to be illustrative. In some implementations, method 200A, 200B may be accomplished with one or more additional operations not described, and/or without one or more of the operations discussed. In some implementations, two or more of the operations may occur substantially simultaneously.

In some implementations, method 200A, 200B may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200A, 200B in response to instructions stored electronically on one or more electronic storage media. The one or more processing devices may include one or more devices configured through hardware, firmware, and/or software to be specifically designed for execution of one or more of the operations of method 200A, 200B.

Referring to FIG. 2A and method 200A, at operation 202, Venturi tube geometry information may be obtained. The Venturi tube geometry information may define geometry of a Venturi tube. In some implementations, operation 202 may be performed by a processor component the same as or similar to the geometry component 102 (Shown in FIG. 1 and described herein).

At operation 204, Venturi tube operation information may be obtained. The Venturi tube operation information may define operating characteristics of the Venturi tube. In some implementations, operation 204 may be performed by a processor component the same as or similar to the operation component 104 (Shown in FIG. 1 and described herein).

At operation 206, liquid property information may be obtained. The liquid property information may define density, viscosity, and expansibility factor of liquid flowing through the Venturi tube. In some implementations, operation 206 may be performed by a processor component the same as or similar to the liquid property component 106 (Shown in FIG. 1 and described herein).

At operation 208, a Reynolds number for the liquid flowing through the Venturi tube may be determined based on the geometry of the Venturi tube, the viscosity of the liquid flowing through the Venturi tube, an estimated liquid flow rate in the Venturi tube, and/or other information. In some implementations, operation 208 may be performed by a processor component the same as or similar to the Reynolds number component 108 (Shown in FIG. 1 and described herein).

At operation 210, Reynolds number-coefficient of discharge correlation information may be obtained. The Reynolds number-coefficient of discharge correlation information may define correlation between Reynolds number and coefficient of discharge for the Venturi tube. In some implementations, operation 210 may be performed by a processor component the same as or similar to the correlation component 110 (Shown in FIG. 1 and described herein).

Referring to FIG. 2B and method 200B, at operation 212, a coefficient of discharge for the liquid flowing through the Venturi tube may be determined based on the Reynolds number for the liquid flowing through the Venturi tube, the correlation between Reynolds number and coefficient of discharge for the Venturi tube, and/or other information. In some implementations, operation 212 may be performed by a processor component the same as or similar to the coefficient of discharge component 112 (Shown in FIG. 1 and described herein).

At operation 214, a liquid flow rate in the Venturi tube may be determined based on the geometry of the Venturi tube, the operating characteristics of the Venturi tube, the expansibility factor of liquid flowing through the Venturi tube, the density of the liquid flowing through the Venturi tube, the coefficient of discharge for the liquid flowing through the Venturi tube, and/or other information. Determination of the Reynolds number, the coefficient of discharge, and the liquid flow rate in the Venturi tube may be iterated based on a comparison between the determined liquid flow rate and the estimated liquid flow rate. In some implementations, operation 214 may be performed by a processor component the same as or similar to the flow rate component 114 (Shown in FIG. 1 and described herein).

At operation 216, liquid flow monitoring for the Venturi tube based on the determined liquid flow rate in the Venturi tube may be facilitated. In some implementations, operation 216 may be performed by a processor component the same as or similar to the monitoring component 116 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for monitoring liquid flow, the system comprising:
one or more physical processors configured by machine-readable instructions to:
obtain Venturi tube geometry information, the Venturi tube geometry information defining geometry of a Venturi tube;
obtain Venturi tube operation information, the Venturi tube operation information defining operating characteristics of the Venturi tube;
obtain liquid property information, the liquid property information defining density, viscosity, and expansibility factor of liquid flowing through the Venturi tube;
determine a Reynolds number for the liquid flowing through the Venturi tube based on the geometry of the Venturi tube, the viscosity of the liquid flowing through the Venturi tube, and an estimated liquid flow rate in the Venturi tube;
obtain Reynolds number-coefficient of discharge correlation information, the Reynolds number-coefficient of discharge correlation information defining a correlation between Reynolds number and coefficient of discharge for the Venturi tube;
determine a coefficient of discharge for the liquid flowing through the Venturi tube based on the Reynolds number for the liquid flowing through the Venturi tube and the correlation between Reynolds number and coefficient of discharge for the Venturi tube;
determine a liquid flow rate in the Venturi tube based on the geometry of the Venturi tube, the operating characteristics of the Venturi tube, the expansibility factor of liquid flowing through the Venturi tube, the density of the liquid flowing through the Venturi tube, and the coefficient of discharge for the liquid flowing through the Venturi tube, wherein determination of the Reynolds number, the coefficient of discharge, and the liquid flow rate in the Venturi tube is iterated based on a comparison between the determined liquid flow rate and the estimated liquid flow rate; and
facilitate liquid flow monitoring for the Venturi tube based on the determined liquid flow rate in the Venturi tube.

2. The system of claim 1, wherein the geometry of the Venturi tube includes an entrance diameter of the Venturi tube and a throat diameter of the Venturi tube.

3. The system of claim 1, wherein iterative determination of the Reynolds number, the coefficient of discharge, and the liquid flow rate in the Venturi tube is performed using linear regression.

4. The system of claim 1, wherein iterative determination of the Reynolds number, the coefficient of discharge, and the liquid flow rate in the Venturi tube includes use of a previously determined liquid flow rate in the Venturi tube as a newly estimated liquid flow rate in the Venturi tube.

5. The system of claim 1, wherein iterative determination of the Reynolds number, the coefficient of discharge, and the liquid flow rate in the Venturi tube is performed until a difference between the estimated liquid flow rate and the determined liquid flow rate is below a liquid flow rate error threshold.

6. The system of claim 1, wherein the operating characteristics of the Venturi tube include temperature, static pressure, and differential pressure.

7. The system of claim 1, wherein the determined liquid flow rate includes a mass flow rate of the liquid flowing through the Venturi tube.

8. The system of claim 7, wherein facilitation of the liquid flow monitoring for the Venturi tube based on the determined liquid flow rate in the Venturi tube includes determination of a line condition volume flow rate and/or a standard condition volume flow rate based on the mass flow rate of the liquid flowing through the Venturi tube.

9. The system of claim 1, wherein the liquid flowing through the Venturi tube includes a mixture of immiscible liquids.

10. The system of claim 1, wherein:
the Venturi tube is connected to a pipe for a compressor; and
facilitation of the liquid flow monitoring for the Venturi tube based on the determined liquid flow rate in the Venturi tube includes prevention of a surge in the compressor based on the determined liquid flow rate in the Venturi tube.

11. A method for monitoring liquid flow, the method comprising:
obtaining Venturi tube geometry information, the Venturi tube geometry information defining geometry of a Venturi tube;
obtaining Venturi tube operation information, the Venturi tube operation information defining operating characteristics of the Venturi tube;
obtaining liquid property information, the liquid property information defining density, viscosity, and expansibility factor of liquid flowing through the Venturi tube;
determining a Reynolds number for the liquid flowing through the Venturi tube based on the geometry of the Venturi tube, the viscosity of the liquid flowing through the Venturi tube, and an estimated liquid flow rate in the Venturi tube;
obtaining Reynolds number-coefficient of discharge correlation information, the Reynolds number-coefficient of discharge correlation information defining a correlation between Reynolds number and coefficient of discharge for the Venturi tube;
determining a coefficient of discharge for the liquid flowing through the Venturi tube based on the Reynolds number for the liquid flowing through the Venturi tube and the correlation between Reynolds number and coefficient of discharge for the Venturi tube;
determining a liquid flow rate in the Venturi tube based on the geometry of the Venturi tube, the operating characteristics of the Venturi tube, the expansibility factor of liquid flowing through the Venturi tube, the density of the liquid flowing through the Venturi tube, and the coefficient of discharge for the liquid flowing through the Venturi tube, wherein determining the Reynolds number, the coefficient of discharge, and the liquid flow rate in the Venturi tube is iterated based on a comparison between the determined liquid flow rate and the estimated liquid flow rate; and
facilitating liquid flow monitoring for the Venturi tube based on the determined liquid flow rate in the Venturi tube.

12. The method of claim 11, wherein the geometry of the Venturi tube includes an entrance diameter of the Venturi tube and a throat diameter of the Venturi tube.

13. The method of claim 11, wherein iteratively determining the Reynolds number, the coefficient of discharge, and the liquid flow rate in the Venturi tube is performed using linear regression.

14. The method of claim 11, wherein iteratively determining the Reynolds number, the coefficient of discharge, and the liquid flow rate in the Venturi tube includes use of a previously determined liquid flow rate in the Venturi tube as a newly estimated liquid flow rate in the Venturi tube.

15. The method of claim 11, wherein iteratively determining the Reynolds number, the coefficient of discharge, and the liquid flow rate in the Venturi tube is performed until a difference between the estimated liquid flow rate and the determined liquid flow rate is below a liquid flow rate error threshold.

16. The method of claim 11, wherein the operating characteristics of the Venturi tube include temperature, static pressure, and differential pressure.

17. The method of claim 11, wherein the determined liquid flow rate includes a mass flow rate of the liquid flowing through the Venturi tube.

18. The method of claim 17, wherein facilitating the liquid flow monitoring for the Venturi tube based on the determined liquid flow rate in the Venturi tube includes determining a line condition volume flow rate and/or a standard condition volume flow rate based on the mass flow rate of the liquid flowing through the Venturi tube.

19. The method of claim 11, wherein the liquid flowing through the Venturi tube includes a mixture of immiscible liquids.

20. The method of claim 11, wherein:
the Venturi tube is connected to a pipe for a compressor; and
facilitating the liquid flow monitoring for the Venturi tube based on the determined liquid flow rate in the Venturi tube includes preventing a surge in the compressor based on the determined liquid flow rate in the Venturi tube.
